(19) United States
(12) Patent Application Publication
(10) Pub. No.: US 2026/0077296 A1
(43) Pub. Date: Mar. 19, 2026

(54) COMPLETE CONVERSION OF SULFUR DIOXIDE TO SULFURIC ACID BY AQUEOUS ACID ABSORPTION

(71) Applicant: Saudi Arabian Oil Company, Dhahran (SA)

(72) Inventors: Guillaume Robert Jean-Francois Raynel, Dhahran (SA); Sebastien A. Duval, Dhahran (SA); Feras Hamad, Dhahran (SA); Khadijah Ghazi Alshadly, Dhahran (SA); Faisal Ibrahim Jassim, Al Jubail (SA)

(21) Appl. No.: 18/886,248

(22) Filed: Sep. 16, 2024

(51) Int. Cl. B01D 53/14; B01D 53/18; B01D 53/34; B01D 53/50; B01D 53/75; B01D 53/78; B01D 61/02; C25B 1/02; C25B 1/22

(52) U.S. Cl. CPC B01D 53/1481; B01D 53/1493; B01D 53/18; B01D 53/343; B01D 53/507; B01D 53/75; B01D 53/78; B01D 61/025; B01D 2251/106; B01D 2251/504; B01D 2251/506; B01D 2257/302; B01D 2258/0283; C25B 1/02; C25B 1/22

(57) ABSTRACT

The technology includes a method for removing sulfur dioxide (SO₂) from a gas stream, where SO₂ gas is contacted by a diluted sulfuric acid (H₂SO₄) stream and absorption takes place in a quench tower. The dissolved SO₂ reacts with the excess of oxygen in the gas stream, where the oxidation results in the formation of sulfurous acid (H₂SO₃) and dilute H₂SO₄. For the complete oxidation of the dissolved SO₂, an electrolyzer and/or liquid injectants are used. This results in the formation of diluted H₂SO₄. The diluted H₂SO₄ is processed in an enrichment unit to produce concentrated H₂SO₄ and fresh water. A portion of the diluted H₂SO₄ and/or fresh water is recycled back to the quench tower for the continued acidic absorption of the incoming SO₂ in the gas stream, thereby not relying on an external water source.

### TECHNICAL FIELD

This disclosure relates to methods of treating sulfur-containing gases in a tail gas stream or a flue gas stream.

### BACKGROUND

Sulfur dioxide (SO₂) is a major contributor to air pollution. SO₂ abatement is essential for protecting public health and the environment. Flue gas from power plants using sulfur containing compounds, such as coal and crude oil, are major emitters of SO₂. Additionally, sulfur recovery units with low efficiency lead to higher SO₂ emission.

To meet environmental regulations, sulfur recovery efficiency must be increased beyond the capabilities of a modified Claus sulfur recovery unit, which typically achieves 98-99% efficiency using a reaction furnace and three-stage catalytic conversion. The primary method to enhance sulfur recovery is by implementing a tail gas treatment process, particularly the reduction-absorption process. In this process, residual sulfur compounds in the tail gas, such as SO₂ and carbonyl sulfide (COS), are converted into H₂S over a hydrogenation catalyst bed. The resulting tail gas stream is then directed to a scrubber, where an amine solution preferentially absorbs H₂S over CO₂. The absorbed H₂S and co-absorbed CO₂ are then returned to the sulfur recovery unit (SRU). However, amine solutions are costly and their regeneration is energy intensive. Therefore, there is a need for a more efficient and cost-effective gas treatment solution for tail gas or flue gas that reduces SO₂ emissions.

### SUMMARY

An embodiment described herein provides a method for removing SO₂ from a gas stream. In some implementations, the method includes receiving a gas stream that includes CO₂, SO₂, water vapor, an excess of O₂, and traces of SO₃ in a quench tower; contacting, in a lower section of the quench tower, the gas stream with a dilute sulfuric acid (H₂SO₄) aqueous solution, thereby forming a condensed water vapor and dissolving SO₂ in the dilute H₂SO₄ aqueous solution or in the condensed water vapor to form a dissolved SO₂ aqueous solution; partially reacting the dissolved SO₂ aqueous solution with the excess of O₂ from the gas stream to form a partially oxidized stream comprising sulfurous acid (H₂SO₃), dilute H₂SO₄, and unoxidized dissolved SO₂; oxidizing completely, from the partially oxidized stream, the unoxidized dissolved SO₂ and H₂SO₃ in an electrolyzer, or oxidizing the unoxidized dissolved SO₂ and H₂SO₃ by adding a liquid oxidant, to form a dilute H₂SO₄ acid stream, resulting in the removal of SO₂; cooling the dilute H₂SO₄ acid stream and splitting the cooled dilute H₂SO₄ acid stream into two portions; flowing a first portion of the cooled dilute H₂SO₄ acid stream to a section above the lower section of the quench tower to contact an incoming gas stream; and flowing a second portion of the cooled dilute H₂SO₄ acid stream to an enrichment unit.

In some implementations, the method further includes producing a permeate stream and a retentate stream from the second portion of the cooled dilute H₂SO₄ acid stream, where the permeate stream includes 0.1-1 wt % of H₂SO₄ acid and the retentate stream includes a concentrated H₂SO₄ acid stream of 30-98 wt %. The retentate stream is flowed to a sulfur recovery unit.

In some implementations, the method further includes flowing the permeate stream to an upper section of the quench tower.

In some implementations, the quench tower has a perforated plate which separates an upper section of the quench tower and the lower section of the quench tower.

In some implementations, the perforated plate distributes the dilute H₂SO₄ aqueous solution into the lower section of the quench tower.

In some implementations, a variation in a flowrate or a composition of the gas stream results in a SO₂ gas breakthrough occurring from the lower section of the quench tower to the upper section of the quench tower.

In some implementations, in response to the SO₂ gas breakthrough in the upper section of the quench tower, an aqueous stream is flowed into the upper section of the quench tower to absorb the SO₂ and oxidize the absorbed SO₂ with the excess of O₂, where the aqueous stream includes a dilute acid water stream or a fresh water stream.

In some implementations, the method further includes a change in a pH of the aqueous stream upon SO₂ gas breakthrough in the upper section of the quench tower, where in response to the change in the pH, the aqueous stream is flowed to the enrichment unit.

In some implementations, the enrichment unit includes a reverse osmosis (RO) membrane, an electrodialysis unit, a distillation unit, or a combination of them.

In some implementations, the liquid oxidant includes nitric acid (HNO₃) or hydrogen peroxide (H₂O₂).

In some implementations, the electrolyzer produces hydrogen (H₂) along with the dilute H₂SO₄ acid stream from the partially oxidized stream.

In some implementations, the dilute H₂SO₄ aqueous solution contacting the gas stream is at a temperature ranging between 40-60° C.

An embodiment described herein provides a system for removing SO₂ from a gas stream. In some implementations, the system includes a thermal oxidizer including a combustion chamber, where the thermal oxidizer is configured to receive a gas stream and where the combustion chamber is configured to combust the gas stream; a waste heat recovery system coupled to the thermal oxidizer, where the waste heat recovery system is configured to cool an effluent stream from the thermal oxidizer; a quench tower that includes a lower section, a mid-section, and an upper section, where the quench tower is configured to receive a cooled effluent stream from the waste heat recovery system; an electrolyzer placed downstream of the quench tower, configured to produce a hydrogen (H₂) stream and a H₂SO₄ acid stream; a cooling system placed downstream of the electrolyzer, configured to cool the H₂SO₄ acid stream; a buffer tank configured to receive a cooled H₂SO₄ acid stream; a first flowline coupled to the buffer tank, where the first flowline is configured to flow a first portion of the cooled H₂SO₄ acid stream from the buffer tank to the quench tower; an enrichment unit placed downstream of the buffer tank, where the enrichment unit is configured to receive a second portion of the cooled H₂SO₄ acid stream from the buffer tank to produce a permeate stream and a retentate stream; and a collection tank placed downstream of the enrichment unit, configured to receive the permeate stream from the enrichment unit.

In some implementations, the gas stream includes hydrogen sulfide (H₂S), sulfur dioxide (SO₂), nitrogen (N₂), carbon dioxide (CO₂), water vapor, traces of sulfur trioxide (SO₃), traces of sulfur vapor, carbon monoxide (CO), carbonyl sulfide (COS), and carbon disulfide (CS₂).

In some implementations, the cooled effluent stream from the waste recovery system includes CO₂, SO₂, water vapor, an excess of O₂, and traces of SO₃.

In some implementations, the lower section of the quench tower includes a packing in which a dilute sulfuric acid (H₂SO₄) aqueous solution contacts the cooled effluent stream to form condensed water vapor and a dissolved SO₂, and further in the lower section a partial reaction of the dissolved SO₂ with the excess O₂ occurs to produce an aqueous H₂SO₄ acid solution, sulfurous acid (H₂SO₃), and unreacted dissolved SO₂.

In some implementations, the system includes two liquid oxidant injection points, where a liquid oxidant is injected which results in complete oxidation of the unreacted dissolved SO₂ flowing out of the quench tower.

In some implementations, the system includes an oxidation-reduction potential (ORP) analyzer placed downstream of the lower section of the quench tower, where the ORP analyzer is configured to measure conversion of dissolved SO₂ into the aqueous H₂SO₄ acid solution.

In some implementations, the enrichment unit includes a reverse osmosis (RO) membrane, an electrodialysis unit, a distillation unit, or a combination of them.

An embodiment described herein provides a method for removing sulfur-containing gases in a tail gas stream. In some implementations, the method includes receiving the tail gas stream that includes CO₂, SO₂, water vapor, an excess of O₂, and traces of SO₃ in a quench tower; contacting the tail gas stream in a lower section of the quench tower with a dilute sulfuric acid (H₂SO₄) aqueous solution to form a condensed water vapor, and to dissolve SO₂ in the dilute H₂SO₄ aqueous solution or in the condensed water vapor to form a dissolved SO₂ aqueous solution; partially reacting the dissolved SO₂ aqueous solution with the excess of O₂ in the tail gas stream to form an aqueous solution, wherein the aqueous solution includes sulfurous acid (H₂SO₃), H₂SO₄ acid, and unreacted dissolved SO₂; oxidizing completely the H₂SO₃ and the unreacted dissolved SO₂ by an electrolyzer or by injecting a liquid oxidant into the aqueous stream to form a H₂SO₄ aqueous stream; flowing a first part of the H₂SO₄ aqueous stream to a reverse osmosis membrane to form a permeate stream that includes a water and a retentate stream, where the retentate stream includes a concentrated H₂SO₄ acid; flowing a second part of the H₂SO₄ aqueous stream to the quench tower.

### BRIEF DESCRIPTION OF DRAWINGS

FIG. 1 is a schematic representation of an exemplary process 100 using a single stage quench tower for SO₂ removal from a tail gas stream.

FIG. 2 is a schematic representation of an exemplary process 200 using a multi-stage quench tower for SO₂ removal from a tail gas stream.

FIG. 3 is a schematic representation of an exemplary process 300 using a polishing-stage quench tower for SO₂ removal from a tail gas stream.

FIG. 4 is a process flow diagram representing the SO₂ absorption from a tail gas stream by an aqueous acid stream.

### DETAILED DESCRIPTION

Disclosed herein is a method and system for efficient and cost-effective removal of SO₂ from a gas stream. The gas stream can include a tail gas stream from a sulfur recovery plant or a flue gas stream which originates from H₂S-containing fuel gases. Tail gas includes H₂S and SO₂. The tail gas is thermally combusted to produce an exhaust gas, which includes SO₂ from the combustion of H₂S. Further SO₃ is produced from the combustion of SO₂ along with an excess of 2-5 vol % of oxygen (O₂).

The method described herein includes a process which absorbs SO₂ from a thermal oxidized tail gas stream by an acidic aqueous solution. The SO₂ which is absorbed by the acidic aqueous solution is partially converted into sulfurous acid (H₂SO₃) and sulfuric acid (H₂SO₄) by reaction with excess oxygen from the thermal oxidized tail gas stream, in aqueous conditions. Further oxidation is performed for the complete conversion of SO₂ and H₂SO₃ into H₂SO₄. The method uses a recycled H₂SO₄ stream which also serves as an O₂ equivalent in the reaction furnace. The use of a recycled H₂SO₄ stream allows for increased SRU plant capacity due to a lower need for combustion air.

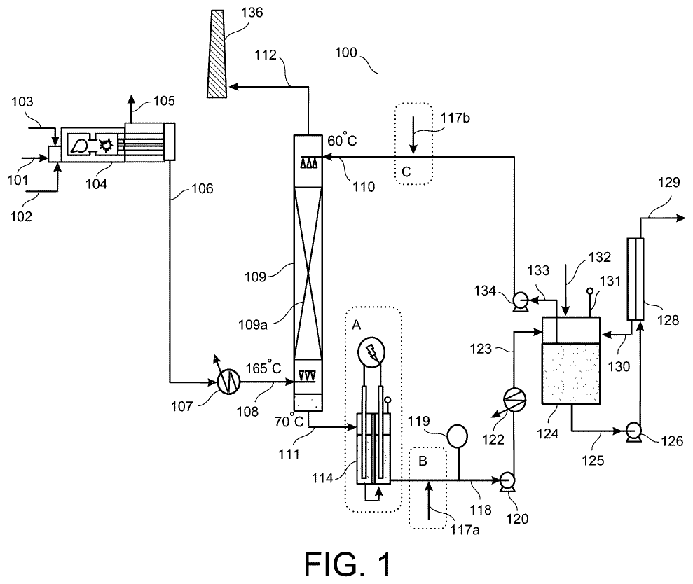

FIG. 1 is a schematic representation of an exemplary process 100 using a single stage quench tower for SO₂ removal from a tail gas stream.

In some implementations, a tail gas from a Claus process includes hydrogen sulfide (H₂S) and SO₂ in a ratio of 2:1, carbon monoxide (CO), and water vapor in a mixture of inert gases such as nitrogen (N₂) and carbon dioxide (CO₂). Additionally, traces of sulfur vapor, carbonyl sulfide (COS), carbon sulfide (CS₂), allotropes of sulfur (S₆, S₇, and S₈), and mixtures thereof are converted to SO₂ by a combustion reaction. To remove the toxic gases from the tail gas, such as the sulfur-containing gases, the tail gas stream 101 along with a combustible gas 102 is sent to a thermal oxidizer 104. In some implementations, the combustible gases include methane and/or an oxidant gas 103, such as O₂ coming from the air or an enriched source.

The combustion reaction transforms the tail gas stream 101 into water vapor, CO₂, SO₂, an excess of O₂ (+2 vol %), and traces of sulfur trioxide (SO₃) in an inert gas (N₂). In some implementations, the heat released by the combustion reaction is partially recovered in an integrated boiler of the thermal oxidizer 104 to produce a high pressure steam stream 105. An exhaust gas 106 exits the thermal oxidizer 104 and is directed to a waste heat boiler 107, where the exhaust gas 106 is cooled. The effluent stream 108 exits the waste heat boiler 107 at a temperature of about 165° C. (above water dewpoint).

The effluent stream 108 is sent to a bottom section of a quench tower 109. The effluent stream 108 is further cooled by a dilute H₂SO₄ aqueous solution 110 that flows from a top section of the quench tower 109. In some implementations, the dilute H₂SO₄ aqueous solution 110 has a temperature between about 40 and 60° C. In some implementations, the dilute H₂SO₄ aqueous solution 110 has a temperature of about 60° C. In some implementations, the cooling action of the dilute H₂SO₄ aqueous solution 110 condenses the water vapor in the effluent stream 108 to form condensed water. Traces of SO₃ can react with condensed water, pure water, or with the dilute H₂SO₄ aqueous solution 110 to give sulfuric acid.

SO₂ is highly soluble in pure water as well as in slightly acidic water (2-20 wt. % sulfuric acid) at an operating temperature ranging between 38° C. to 60° C. Furthermore, SO₂ hydrates in water and reacts readily (E^{o}=+1.1301 V) with the excess of O₂ from the effluent stream 108. The SO₂ reaction with O₂ takes place in the aqueous phase as per the following oxido-reduction reaction (R.1).

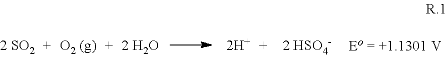

The product of this reaction is sulfuric acid. The rate of this reaction is dependent on the temperature and on the concentration of hydrated SO₂. The rate of this oxidation reaction is expressed as Eq. 1:

$$r = {k [ {SO}_{2} \cdot {H}_{2} O ]}^{\frac{3}{2}} \qquad Eq . 1$$

where the rate constant k (L^{3/2}·mol^{-1/2}·s⁻¹) is expressed as Eq. 2:

$$k = 1.95 \times {10}^{13} e ( - 860 \; 00 / R \cdot T ) \qquad Eq . 2$$

where R is the universal gas constant and T is the temperature (K).
The rate of the reaction (R. 1) increases as the temperature of the reaction increases and is not disturbed by the presence of sulfuric acid.

The reaction R.1 combined with the conversion of SO₃ to sulfuric acid occurs in a packing zone 109a of the quench tower 109. In some implementations, the packing zone 109a is a section that has a large surface area for contact of the gaseous phase and the liquid phase for absorption to take place. For example, SO₂ is the gas that is absorbed by the dilute H₂SO₄ aqueous solution 110. The packing zone 109a also promotes bulk mixing in each phase to avoid concentration polarization in the gaseous phase and/or the liquid phase. In some implementations, the packing zone 109a includes pall rings, raschig rings, porous plates, metal rings, clay, graphite, and ceramic material. In some implementations, the packing zone 109a includes structured packing or random packing.

In some implementations, the addition of condensed water (formed by the cooling action on the water vapor in the effluent stream 108) and the produced sulfuric acid (formed from reaction R.1 and conversion of SO₃ to sulfuric acid) to the dilute H₂SO₄ aqueous solution 110 maintains a mass concentration of the sulfuric acid between 0.2 to 20 wt. % at the bottom of the quench tower. Further as the reaction proceeds, a cleaned gas stream 112 is formed which leaves the quench tower 109 from the top. The cleaned gas stream 112 includes water vapor, CO₂, N₂, and a small amount of O₂. The cleaned gas stream 112 is sent to a stack 136.

Following the reaction R.1 in the packing zone 109a, a partially oxidized stream 111 is formed and exits the lower section of the quench tower 109 at a temperature of about 70° C. The partially oxidized stream 111 includes sulfurous acid (H₂SO₃), a dilute H₂SO₄ acid, and an unoxidized dissolved SO₂. In some implementations, the partially oxidized stream 111 is directed to an oxidation-reduction potential (ORP) analyzer 119 to determine if the dissolved SO₂ is fully converted into sulfuric acid. In case the ORP analyzer determines that SO₂ is not fully converted into sulfuric acid, additional oxidation can be performed by an electrolyzer 114.

In some implementations, additional oxidation is performed by the injection of a liquid oxidant at an injection point 117a, downstream of the electrolyzer. In some implementations, the liquid oxidant is injected at an injection point 117b along a flowline which is directed towards the top section of the quench tower 109. In some implementations, additional oxidation is performed by both the electrolyzer 114 and the injection of a liquid oxidant. The liquid oxidants can include nitric acid (HNO₃) or hydrogen peroxide (H₂O₂). The use of a liquid oxidant produces sulfuric acid and proceeds via reaction R.2 and R.3.

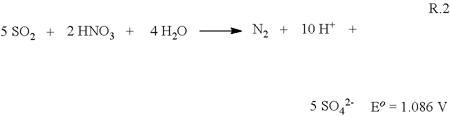

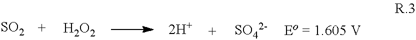

The reaction in the electrolyzer 114 produces hydrogen as well as sulfuric acid and proceeds via reaction R.4.

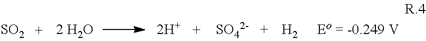

After complete oxidation of SO₂, a dilute H₂SO₄ stream 118 is formed and sent by a pump 120 to a cooler 122. The cooler 122 can include a heat exchanger or an air cooler. The dilute H₂SO₄ stream 118 is cooled from a temperature of about 70-80° C. to about 50-60° C. by the cooler 122. After cooling, the cooled dilute H₂SO₄ stream 123 is sent to a buffer tank 124. The cooled dilute H₂SO₄ stream 123 collects in the buffer tank 124. The buffer tank 124 is fitted with a vent 131, where a blanket of inert atmosphere is provided by injecting inert gas. The vent 131 is used to avoid any potential SO₂ emission. In some implementations, the vent 131 is equipped with a small column where a clean water stream is circulated. In some implementations, the vent 131 is equipped with a gas line that includes a water trap. In some implementations, a make-up water stream 132 is used to fill the buffer tank 124 prior to the startup of the process. The make-up water stream 132 is used only at the start of the process.

From the buffer tank 124, two streams are formed from the collected cooled dilute H₂SO₄ and the two streams are directed by a regulated flow valve (now shown) installed at the exit of the buffer tank 124. A first portion 133 of the collected cooled dilute H₂SO₄ exits the buffer tank 124 and is directed by a pump 134 to the flowline that flows the dilute H₂SO₄ aqueous solution 110, towards the top of the quench tower 109. A second portion 125 of the collected cooled dilute H₂SO₄ exits the buffer tank 124 and is flowed via a pump 126 to a H₂SO₄ enrichment unit 128.

The enrichment unit 128 is used to concentrate sulfuric acid. The enrichment unit can include a desalination unit that uses a membrane based process. In some implementations, a reverse osmosis (RO) membrane, nanofiltration (NF) membrane, or ultrafiltration (UF) membrane is used. The RO membrane is used to concentrate sulfuric acid up to 10-20 wt. %. In some implementations, the enrichment unit 128 includes an electrodialysis unit or a distillation column. The electrodialysis unit can concentrate sulfuric acid up to 10-30 wt %. The distillation column can concentrate sulfuric acid up to 98 wt %, using part of the steam generated from the thermal oxidizer 104. In some implementations, a combination of these units is used to concentrate sulfuric acid. For example, an RO membrane can remove about 96-97% of the water, leaving 3-4% water at 10 wt % of H₂SO₄ to be treated by a vacuum distillation.

The enrichment unit 128 produces a permeate stream 130 and a retentate stream 129. The permeate stream 130 is mainly water with less than 0.1-1 wt % of sulfuric acid (pH around 1). In some implementations, the permeate stream 130 is sent to the buffer tank 124. In some implementations, the permeate stream 130 is sent to an evaporation pond, when the buffer tank 124 is full. The retentate stream 129 is mainly concentrated sulfuric acid. In some implementations, the concentrated sulfuric acid has a concentration of 30-98 wt %. The retentate stream 129 can be monetized by producing concentrated sulfuric acid or sent to the sulfur recovery unit (SRU) to enrich in O₂ equivalent a Claus furnace.

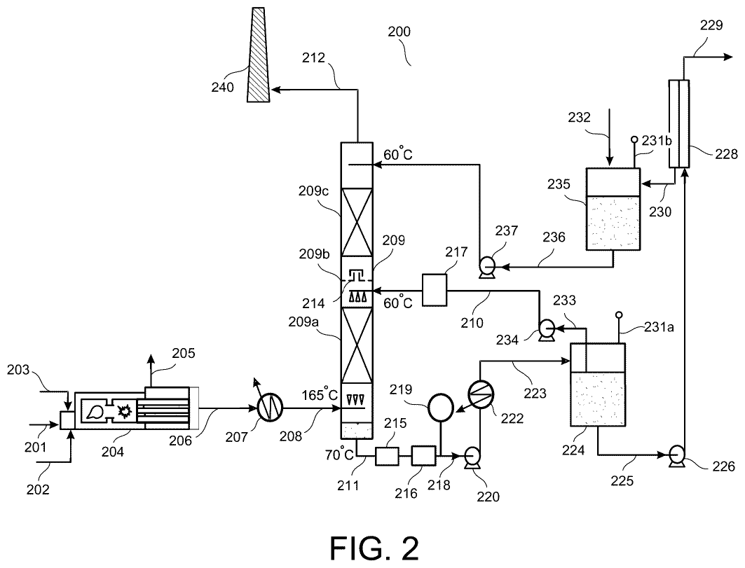

FIG. 2 is a schematic representation of an exemplary process 200 using a multi-stage quench tower for SO₂ removal from a tail gas stream.

A tail gas stream 201 is introduced into a thermal oxidizer 204. The tail gas stream 201 includes H₂S and SO₂ in a ratio of 2 to 1 and water vapor in a mixture of inert gases (N₂ and CO₂). The tail gas stream 201 also has traces of sulfur vapor, COS, CS₂, and CO. Most of these gases are highly toxic. To remove the sulfur-containing gases, the tail gas stream 201 undergoes combustion by a combustible gas 202. In some implementations, the combustible gas 202 includes methane. In some implementations, an oxidant gas 203, such as O₂ from the air or an enriched source is used for the combustion reaction. The combustion reaction transforms the tail gas stream 201 into water vapor, CO₂, SO₂, an excess of O₂ (+2 vol %), and traces of SO₃ in an inert gas (N₂). The combustion reaction in the thermal oxidizer 204 takes place at a temperature range of 900-1200° C. The heat released by the combustion reaction is partially recovered in an integrated boiler of the thermal oxidizer 204 to produce high pressure steam 205.

The exhaust gas 206 from the thermal oxidizer 204 is directed to a waste heat boiler 207, where the exhaust gas 206 is cooled. The effluent stream 208 from the waste heat boiler 207 is at a temperature of about 165° C. (above water dewpoint). Maintaining the effluent stream 208 above the water dewpoint prevents water condensation in the pipe. The effluent stream 208 is directed towards the lower section 209a of the quench tower 209. The effluent stream 208 from the waste heat boiler 207 is further cooled by a dilute H₂SO₄ aqueous solution 210. The concentration of H₂SO₄ in the dilute H₂SO₄ aqueous solution 210 is between 0.2-20 wt %. The dilute H₂SO₄ aqueous solution 210 flows below a perforated plate 214 placed above the lower section of the quench tower 209a. The perforated plate 214 serves as a liquid distributor for the upper section 209c. In some implementations, the liquid distributor includes a spray plate to distribute the highly diluted acidic aqueous solution 236 on the packing of the lower section 209a. The liquid distributor 214 is placed in the mid-section 209b of the quench tower 209.

The lower section 209a of the quench tower 209 includes a packing zone. In some implementations, the packing zone includes pall rings, raschig rings, porous plates, metal rings, clay, graphite, or ceramic material. In some implementations, the packing zone includes structured packing or random packing. In some implementations, the gas and liquid contact occurs at the entry of the lower section of the quench tower 209. However, below the lower section of the quench tower 209a, the gas and liquid contact is low. The gas and liquid contact in the packing zone of the lower section of the quench tower 209a is significantly improved due to the surface area of the packing material.

In some implementations, the dilute H₂SO₄ aqueous solution 210 has a temperature between about 40 and 60° C. In some implementations, the dilute H₂SO₄ aqueous solution 210 has a temperature of about 60° C. The cooling action of the dilute H₂SO₄ aqueous solution 210 condenses the water vapor entrained in the incoming effluent stream 208. Traces of SO₃ from the incoming effluent stream 208 can react with condensed water, pure water, or in slightly acidic water to give sulfuric acid.

SO₂ is also greatly soluble in pure water as well as in slightly acidic water (2-20 wt. % sulfuric acid) at an operating temperature of about 38° C. to 60° C. Furthermore, the SO₂ dissolves in water to form a dissolved SO₂ aqueous solution. The SO₂ in the dissolved SO₂ aqueous solution reacts readily (E^{o}=+1.1301 V) with the excess of O₂ from the incoming effluent stream 208. O₂ can be dissolved in water at lower concentrations. The dissolved SO₂ reacts readily with the first molecule of O₂ dissolved in water. The dissolved SO₂ can also react with the O₂ gas that is present close to the water surface. The product of this reaction is sulfuric acid. The rate of this reaction depends on the temperature and on the concentration of dissolved SO₂ as shown in Eq.1. The rate of this reaction increases as the temperature of the reaction increases and is not disturbed by the presence of sulfuric acid. This reaction occurs in a packing zone of the lower section of the quench tower 209a.

As the reaction proceeds, a cleaned gas stream 212 exits from the lower section 209a of the quench tower 209. The cleaned gas stream 212 includes water vapor, CO₂, N₂, and a small amount of O₂. In some implementations, the cleaned gas stream 212 exits from the upper section 209c of the quench tower 209. The upper section 209c of the quench tower 209 includes a packing zone. The packing zone can include pall rings, raschig rings, porous plates, metal rings, clay, graphite, or ceramic material. The cleaned gas stream 212 is sent to the stack 240.

The addition of the condensed water (formed by the cooling action on the water vapor) and the produced sulfuric acid (formed by the reaction of dissolved SO₂ with O₂ and the SO₃ reaction with the water) to the dilute H₂SO₄ aqueous solution 210 maintains a mass concentration of sulfuric acid between 0.2 and 20 wt. % at the bottom of the quench tower. A partially oxidized stream 211, which includes H₂SO₃, dilute H₂SO₄ acid, and an unoxidized dissolved SO₂ exits the quench tower 209 from the bottom. In some implementations, in the quench tower 209, about 1 to 50 wt % of dissolved SO₂ is converted into sulfuric acid depending on the temperature and the hydrodynamics of the quench tower 209. The partially oxidized stream 211 has a temperature of about 70° C.

In some implementations, the partially oxidized stream 211 is directed to an oxidation-reduction potential (ORP) analyzer 219 to determine if the dissolved SO₂ is fully converted into sulfuric acid. In case the ORP analyzer determines that SO₂ is not fully converted into sulfuric acid, additional oxidation is performed. In some implementations, additional oxidation is performed by an electrolyzer 215. In an electrolyzer 215, hydrogen and sulfuric acid are formed. In some implementations, a liquid oxidant is injected at injection points 216 or 217 for additional oxidation. The liquid oxidant can include HNO₃ or H₂O₂. The injection of a liquid oxidant to the partially oxidized stream 211 produces sulfuric acid. The additional oxidation results in a complete conversion (nearly 100%) of SO₂ and H₂SO₃ into H₂SO₄. Complete conversion of SO₂ to H₂SO₄ is necessary for the enrichment of H₂SO₄. This results in a dilute H₂SO₄ stream 218 (0.1-1 wt % higher than stream 211) that is sent via a pump 220 to a cooler 222. The cooler 222 can include an air cooler or a heat exchanger. The dilute sulfuric acid is cooled from a temperature of about 70-80° C. to a temperature of about 50-60° C. The cooled dilute H₂SO₄ stream 223 is flowed into a buffer tank 224.

The cooled dilute H₂SO₄ stream 223 is collected in the buffer tank 224. The collected cooled dilute H₂SO₄ in the buffer tank 224 is split into two streams. A first stream 233 exits the buffer tank 224 and is flowed via a pump 234 to merge with the dilute H₂SO₄ aqueous solution 210. In some implementations, the buffer tank is fitted with a vent 231a, where a blanket of atmosphere is provided by injecting an inert gas. The vent 231a prevents any potential SO₂ emission. In some implementations, the vent 231a is equipped with a small column where a clean water stream is circulated. In some implementations, the vent 231a is equipped with a gas line that includes a water trap.

A second stream 225 from the buffer tank 224 is sent via a pump 226 to an enrichment unit 228. In some implementations, the enrichment unit 228 can include a water treatment unit such as an RO membrane. The RO membrane can concentrate sulfuric acid up to 10-20 wt %. In some implementations, the enrichment unit 228 includes an electrodialysis unit, which can concentrate sulfuric acid up to 10-30 wt %. In some implementations, the enrichment unit 228 includes a distillation column, which can concentrate sulfuric acid up to 98 wt %. In some implementations, the distillation column uses a part of the steam generated from the thermal oxidizer 204 or from the waste heat recovery system installed downstream of the reaction furnace of the Claus process. In some implementations, a combination of these units is used for the enrichment process.

The enrichment unit 228 produces a permeate stream 230, which is mainly water with less than 0.1 wt. % of sulfuric acid (pH around 1) and a retentate stream 229, which is concentrated sulfuric acid. In some implementations, the concentrated sulfuric acid has a concentration of about 30-98 wt %. In some implementations, the permeate stream 230 is sent to a collection tank 235. The collection tank is fitted with a vent 231b, where a blanket of inert atmosphere is provided by injecting inert gas. The vent 231b prevents the potential SO₂ emission. In some implementations, a water stream 232 is injected into the collection tank which is primarily used only at the start of the process. In some implementations, the permeate stream 230 is sent to an evaporation pond, when the collection tank 235 is full.

The retentate stream 229 can be monetized by producing concentrated sulfuric acid. In some implementations, the retentate stream 229 is sent to the SRU to enrich the Claus furnace. A highly diluted acidic water stream 236 from the collection tank 235 is flowed via a pump 237 to the top section 209c of the quench tower 209. The top section 209c is connected to the lower section 209a of the quench tower 209 by the perforated plate 214. The perforated plate 214 is used to redistribute the highly diluted acidic water stream 236 on the packing of the lower section 209a.

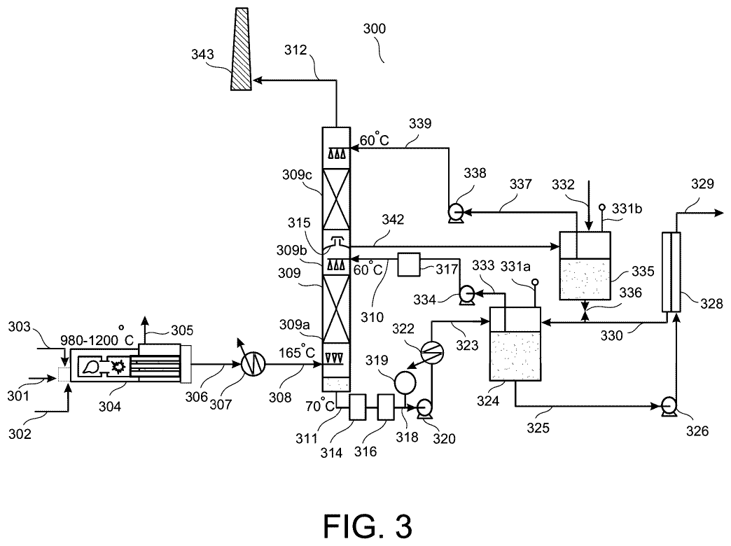

FIG. 3 is a schematic representation of an exemplary process 300 using a polishing-stage (to absorb any escaped SO₂ from the lower section of the quench tower) quench tower for SO₂ removal from a tail gas stream.

A tail gas stream 301 is introduced into a thermal oxidizer 304. The tail gas stream 301 includes H₂S and SO₂ in a ratio 2 to 1 and water vapor in a mixture of inert gases (N₂ and CO₂). The tail gas stream 301 also has traces of sulfur vapor, COS, CS₂, and CO. Most of these gases are highly toxic. To remove the sulfur-containing gases, the tail gas stream 301 undergoes combustion by a combustible gas 302. In some implementations, the combustible gas 302 includes methane. In some implementations, an oxidant gas 303, such as O₂ from the air or an enriched source is used for the combustion reaction. The combustion reaction transforms the tail gas stream 301 into water vapor, CO₂, SO₂, an excess of O₂ (+2 vol %), and traces of SO₃ in an inert gas (N₂). The combustion reaction in the thermal oxidizer 304 takes place at a temperature range of about 900-1200° C. The heat released by the combustion reaction is partially recovered in an integrated boiler of the thermal oxidizer 304 to produce high pressure steam 305.

The exhaust gas 306 from the thermal oxidizer 304 is directed to a waste heat boiler 307, where the exhaust gas 306 is cooled. The effluent stream 308 from the waste heat boiler 307 is at a temperature of about 165° C. (above water dewpoint). The effluent stream 308 is directed towards the lower section 309a of the quench tower 309. The quench tower 309 has three sections: a lower section 309a, a mid-section 309b, and an upper section 309c. The lower section 309a and the upper section 309c are separated by a plate 315 placed in the mid-section 309b. The plate 315 has bubble caps which lets gas to pass through it and also collects the liquid. The lower section 309a and the upper section 309c have a packing zone. The packing zone includes pall rings, raschig rings, porous plates, metal rings, clay, graphite, or ceramic material. In some implementations, the packing zone includes structured packing or random packing.

After entering the lower section 309a, the effluent stream 308 from the waste heat boiler 307 is further cooled by a dilute H₂SO₄ aqueous solution 310 flowing from above the lower section 309a. In some implementations, the dilute H₂SO₄ aqueous solution 310 has a temperature between 4° and 60° C. In some implementations, the diluted H₂SO₄ aqueous solution 310 has a temperature of about 60° C. The cooling action of the dilute H₂SO₄ aqueous solution 310 condenses the water vapor entrained in the incoming effluent stream 308. Traces of SO₃ from the incoming effluent stream 308 can react with condensed water, pure water, or in slightly acidic water to give sulfuric acid.

SO₂ is also highly soluble in pure water as well as in slightly acidic water (2-20 wt. % sulfuric acid) at an operating temperature of about 38° C. to 60° C. Furthermore, the SO₂ dissolves in water to form a dissolved SO₂ aqueous solution. The SO₂ in the dissolved SO₂ aqueous solution reacts readily (E^{o}=+1.1301 V) with the excess of O₂ from the incoming effluent stream 308. The rate of this reaction depends only on the concentration of the dissolved SO₂. The rate of this reaction increases as the temperature of the reaction increases and is not disturbed by the presence of sulfuric acid. The reaction takes place in the packing zone of the lower section 309a of the quench tower 309.

As the reaction proceeds, a cleaned gas stream 312 exits the quench tower from the lower section 309a and from the upper section 309c of the quench tower 309. The cleaned gas stream 312 includes water vapor (H₂O), CO₂, N₂ and a small amount of O₂. The cleaned gas stream 312 is sent to the stack 343.

The addition of the condensed water (formed by the cooling action on the water vapor) and the produced sulfuric acid (formed by the reaction of dissolved SO₂ with O₂ and the SO₃ reaction with the water) to the dilute H₂SO₄ aqueous solution 310 maintains a mass concentration of sulfuric acid between 0.2 and 20 wt. % at the bottom of the quench tower. A partially oxidized stream 311, which includes H₂SO₃, a dilute H₂SO₄ acid, and an unoxidized dissolved SO₂ exits the quench tower 309 from the bottom. The partially oxidized stream 311 has a temperature of about 70° C.

In some implementations, the partially oxidized stream 311 is directed to an ORP analyzer 319 to determine if the dissolved SO₂ is fully converted into sulfuric acid. In case the ORP analyzer 319 determines that SO₂ is not fully converted into sulfuric acid, additional oxidation is performed for complete conversion of SO₂ and H₂SO₃ to H₂SO₄. In some implementations, additional oxidation is performed by an electrolyzer 314. In an electrolyzer 314, hydrogen and sulfuric acid are formed. In some implementations, a liquid oxidant is injected at injection points 316 or 317 for additional oxidation. The liquid oxidant can include HNO₃ or H₂O₂. In some implementations, both an electrolyzer 314 and a liquid oxidant is used for oxidation. The injection of a liquid oxidant to the partially oxidized stream 311 produces sulfuric acid. The additional oxidation results in a complete conversion of SO₂ and H₂SO₃ into H₂SO₄. Complete conversion of SO₂ to H₂SO₄ is necessary for the enrichment of H₂SO₄. This results in a dilute H₂SO₄ stream 318 that is sent via a pump 320 to a cooler 322. The cooler 322 can include an air cooler or a heat exchanger. The dilute sulfuric acid is cooled from a temperature of about 70-80° C. to a temperature of about 50-60° C. The cooled dilute H₂SO₄ 323 is flowed to a buffer tank 324.

The cooled dilute H₂SO₄ 323 is collected in the buffer tank 324. The collected dilute H₂SO₄ in the buffer tank 324 is split into two streams. A first stream 333 exits the buffer tank 324 and is flowed via a pump 334 and is merged with the dilute H₂SO₄ aqueous solution 310. The dilute H₂SO₄ aqueous solution 310 flows above the lower section 309a of the quench tower 309. In some implementations, the buffer tank 324 is fitted with a vent 331a, where a blanket of atmosphere is provided by injecting an inert gas. The vent 331a prevents any potential SO₂ emission. In some implementations, the vent 331a is equipped with a small column where a clean water stream is circulated. In some implementations, the vent 331a is equipped with a gas line that includes a water trap.

A second stream 325 from the buffer tank 324 is sent via a pump 326 to an enrichment unit 328. In some implementations, the enrichment unit 328 includes a water treatment unit such as an RO membrane. The RO membrane can concentrate sulfuric acid up to 10-20 wt %. In some implementations, the enrichment unit 328 includes an electrodialysis unit, which can concentrate sulfuric acid up to 10-30 wt %. In some implementations, the enrichment unit 328 includes a distillation column, or a combination of an RO, electrodialysis unit, and a distillation column to concentrate sulfuric acid up to 97-98 wt %. In some implementations, the distillation column uses a part of the steam generated from the thermal oxidizer 304 or from the waste heat recovery system installed downstream of the reaction furnace of the Claus process.

The enrichment unit 328 produces a permeate stream 330, which is mainly water with less than 1 wt. % of sulfuric acid (pH around 1) and a retentate stream 329, which is concentrated sulfuric acid (10-98 wt %). In some implementations, the permeate stream 330 is sent to the buffer tank 324. In some implementations, the permeate stream 330 is sent to an evaporation pond (now shown) if the buffer tank 324 is full. The retentate stream 329 can be monetized by producing concentrated sulfuric acid. In some implementations, the retentate stream 329 is sent to the SRU to enrich the Claus furnace.

The oxidation of the dissolved SO₂ into sulfuric acid occurs partially in the packing zone of the lower section 309a of the quench tower 309. If there is a variation (upset) in the composition or flowrate of the exhaust gas 306 from the thermal oxidizer 304, the SO₂ gas breaks through from the lower section 309a of the quench tower 309 and enters the upper section 309c. In this case, the SO₂ is absorbed in the upper section 309c using fresh water stream 339 (which can also be a highly diluted acidic stream) from a collection tank 335.

The collection tank 335 is fitted with a vent 331b, where a blanket of inert atmosphere is provided by injecting inert gas. The vent 331b prevents the potential SO₂ emission. In some implementations, a water stream 332 is used to fill the collection tank prior to the start of the process. The water stream 332 is primarily used only at the start of the process. The fresh water or the highly diluted acidic water stream 337 from the collection tank 335 is sent to the upper section 309c using a pump 338, as a fresh water stream 339. The upper section 309c is connected to the lower section 309a of the quench tower 309 by the plate 315 as described earlier. In some implementations, the plate 315 lets the gas (O₂ and SO₂) through via bubble caps and collects the fresh water stream 339 flowing from the upper section 309c. In some implementations, the water collected by the plate 315 is sent back to the buffer tank 335 via line 342. In some implementations, if a small amount of diluted H₂SO₄ is formed in the upper section of the quench tower 309c, it will stay in the upper loop until the pH is too low. When the pH is too low the fresh water stream 339 can be changed.

As the breakthrough of SO₂ (and/or SO₃) happens, the pH of the fresh water stream 339 decreases from 3 (0.01 wt. % sulfuric acid) to 0.5 (3 wt. % sulfuric acid). When the pH reaches 0.5, the highly diluted acidic water stream 337 exiting the collection tank 335 is diverted using the valve 336 to the buffer tank 324, into the line that flows the permeate stream 330. The highly diluted acidic water stream 337 is therefore treated in the enrichment unit 328. A fresh water stream is added through the line flowing the water stream 332 into the collection tank 335 which is further used for the absorption process in the upper section 309c of the quench tower 309.

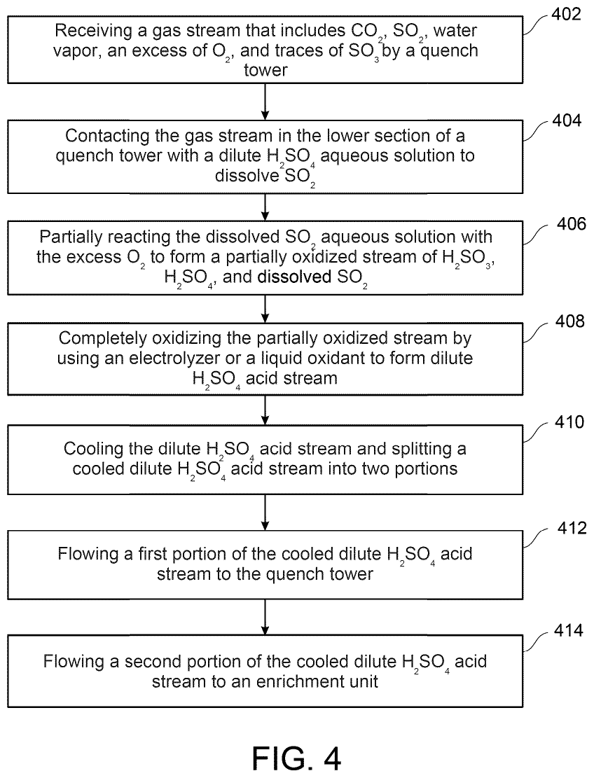

FIG. 4 is a process flow diagram representing the SO₂ absorption from a tail gas stream by an aqueous acid stream.

At block 402, a quench tower receives a gas stream that includes water vapor, CO₂, SO₂, an excess of O₂ (+2 vol %), and traces of SO₃ in an inert gas (N₂). In some implementations, these gas mixtures are a product of a combustion reaction of a flue gas or a tail gas stream. The combustion reaction of the flue gas or tail gas stream takes place in a thermal oxidizer at 900-1200° C. The exhaust gases from the thermal oxidizer are cooled to about 165° C. before flowing it towards a quench tower.

At block 404, the gas stream is further cooled by contacting with a dilute H₂SO₄ aqueous solution in the lower section of the quench tower. The lower section of the quench tower has a packing zone. In some implementations, the dilute H₂SO₄ aqueous solution has a temperature of about 40-60° C. The cooling action by the dilute H₂SO₄ aqueous solution produces a condensed water. Further, the SO₂ in the gas stream dissolves in the dilute H₂SO₄ aqueous solution to form a dissolved SO₂ aqueous solution. In some implementations, traces of SO₃ reacts with the condensed water to form dilute H₂SO₄.

At block 406, the dissolved SO₂ aqueous solution partially reacts with the excess O₂ from the incoming gas stream in the lower section of the quench tower. The reaction takes place in the packing zone of the lower section of the quench tower. In some implementations, the reaction takes place in the packing zone of the upper section of the quench tower, especially when there is a variation in the flowrate or composition of the incoming gas stream resulting in a SO₂ gas breakthrough from the lower section into the upper section of the quench tower. The reaction in the lower section of the quench tower results in a partially oxidized stream which includes H₂SO₃, H₂SO₄, and dissolved SO₂.

At block 408, the partially oxidized stream undergoes further oxidation by an electrolyzer or by the injection of a liquid oxidant. In some implementations, both an electrolyzer and the injection of a liquid oxidant is used for the complete oxidation of H₂SO₃ and dissolved SO₂ to H₂SO₄. In some implementations, the liquid oxidants include HNO₃ or H₂O₂. The use of both these liquid oxidants results in the formation of H₂SO₄. In some implementations, the electrolyzer produces hydrogen and H₂SO₄. The complete oxidation results in a dilute H₂SO₄ acid stream.

At block 410, the dilute H₂SO₄ acid stream is cooled by a cooler. In some implementations, the cooler includes a heat exchanger or an air cooler. The cooled dilute H₂SO₄ acid stream is collected in a buffer tank. From the buffer tank the cooled dilute H₂SO₄ acid stream is split into two streams.

At block 412, the first portion of the cooled dilute H₂SO₄ acid stream is sent to the quench tower above the packing of the lower section of the quench tower to further cool the incoming gas stream.

At block 414, the second portion of the cooled dilute H₂SO₄ acid stream is sent to an enrichment unit. In some implementations, the enrichment unit produces a permeate stream which is substantially water and a retentate stream which includes concentrated sulfuric acid. In some implementations, the permeate stream flows into a collection tank. In some implementations, a portion of the permeate stream from the collection tank flows into the upper section of the quench tower.

Implementations disclosed herein relate to the absorption of SO₂ and sulfur-containing gases from a tail gas stream or a flue gas stream. The absorption of SO₂ takes place in a quench tower by the contact of a dilute H₂SO₄ aqueous stream. The absorbed SO₂ and H₂SO₃ in the aqueous phase reacts partially with the excess of O₂ in the incoming tail gas stream or flue gas stream to form H₂SO₄. Further oxidation using an electrolyzer or a liquid oxidant results in complete conversion of SO₂ and H₂SO₃ into H₂SO₄. The produced H₂SO₄ is enriched by a membrane separation process to produce concentrated H₂SO₄. The permeate stream formed from the membrane separation process includes a very dilute H₂SO₄ concentration. The permeate stream is further flowed to the quench tower to cool the incoming gas stream, thereby recycling the produced dilute H₂SO₄ stream for the SO₂ absorption process. The retentate stream formed from the membrane separation process includes concentrated sulfuric acid, which can be monetized or used for other processes such as fertilizer manufacture, use as electrolytes in batteries, metal processing, manufacturing dyes, papers, glass, or astringents.

The advantage of the reaction between O₂ and SO₂ in the water phase in the quench tower is that maintaining water at a low temperature does not require a large energy. The cooling can also be performed by an air cooler. Further, the process in the quench tower does not require additional chemicals or make-up water. The method of SO₂ absorption disclosed herein does not use an amine solution for scrubbing. Therefore, the method has reduced heating/cooling requirements, as there is no amine regeneration. Further, sulfuric acid recovery or concentration uses a physical separation process which consumes low energy.

Other implementations are also within the scope of the following claims.

### Exemplary Embodiments

1. A method for removing sulfur dioxide (SO₂) from a gas stream, the method comprising:
receiving a gas stream comprising CO₂, SO₂, water vapor, an excess of O₂, and traces of SO₃ in a quench tower;
contacting, in a lower section of the quench tower, the gas stream with a dilute sulfuric acid (H₂SO₄) aqueous solution, thereby:
   forming a condensed water vapor; and
   dissolving SO₂ in the dilute H₂SO₄ aqueous solution or in the condensed water vapor to form a dissolved SO₂ aqueous solution;
partially reacting the dissolved SO₂ aqueous solution with the excess of O₂ from the gas stream to form a partially oxidized stream comprising sulfurous acid (H₂SO₃), dilute H₂SO₄, and unoxidized dissolved SO₂;
oxidizing completely, from the partially oxidized stream, the unoxidized dissolved SO₂ and H₂SO₃ in an electrolyzer, or oxidizing the unoxidized dissolved SO₂ and H₂SO₃ by adding a liquid oxidant, to form a dilute H₂SO₄ acid stream, thereby resulting in the removal of SO₂;
cooling the dilute H₂SO₄ acid stream and splitting the cooled dilute H₂SO₄ acid stream into two portions;
flowing a first portion of the cooled dilute H₂SO₄ acid stream to a section above the lower section of the quench tower to contact an incoming gas stream; and
flowing a second portion of the cooled dilute H₂SO₄ acid stream to an enrichment unit.
   2. The method of embodiment 1, further comprising producing a permeate stream and a retentate stream from the second portion of the cooled dilute H₂SO₄ acid stream wherein:
the permeate stream comprises 0.1-1 wt % of H₂SO₄ acid; and
the retentate stream comprises a concentrated H₂SO₄ acid stream of 30-98 wt %, wherein the retentate stream is flowed to a sulfur recovery unit.
   3. The method of embodiment lor 2, further comprising flowing the permeate stream to an upper section of the quench tower.
   4. The method of any of embodiments 1-3, wherein the quench tower has a perforated plate which separates an upper section of the quench tower and the lower section of the quench tower.
   5. The method of any of embodiments 1-4, wherein the perforated plate distributes the dilute H₂SO₄ aqueous solution into the lower section of the quench tower.
   6. The method of any of embodiments 1-5, wherein a variation in a flowrate or a composition of the gas stream results in a SO₂ gas breakthrough occurring from the lower section of the quench tower to the upper section of the quench tower.
   7. The method of any of embodiments 1-6, wherein in response to the SO₂ gas breakthrough in the upper section of the quench tower, an aqueous stream is flowed into the upper section of the quench tower to absorb the SO₂ and oxidize the absorbed SO₂ with the excess of O₂, wherein the aqueous stream comprises a dilute acid water stream or a fresh water stream.
   8. The method of any of embodiments 1-7, further comprising a change in a pH of the aqueous stream upon SO₂ gas breakthrough in the upper section of the quench tower, wherein in response to the change in the pH, the aqueous stream is flowed to the enrichment unit.
   9. The method of any of embodiments 1-8, wherein the enrichment unit comprises a reverse osmosis (RO) membrane, an electrodialysis unit, a distillation unit, or a combination thereof.
   10. The method of any of embodiments 1-9, wherein the liquid oxidant comprises nitric acid (HNO₃) or hydrogen peroxide (H₂O₂).
   11. The method of any of embodiments 1-10, wherein the electrolyzer produces hydrogen (H₂) along with the dilute H₂SO₄ acid stream from the partially oxidized stream.
   12. The method of any of embodiments 1-11, wherein the dilute H₂SO₄ aqueous solution contacting the gas stream is at a temperature ranging between 40-60° C.
   13. A system for removing sulfur dioxide (SO₂) from a gas stream, the system comprising:
a thermal oxidizer comprising a combustion chamber, wherein the thermal oxidizer is configured to receive a gas stream and wherein the combustion chamber is configured to combust the gas stream;
a waste heat recovery system coupled to the thermal oxidizer, wherein the waste heat recovery system is configured to cool an effluent stream from the thermal oxidizer;
a quench tower comprising a lower section, a mid-section, and an upper section, wherein the quench tower is configured to receive a cooled effluent stream from the waste heat recovery system;
an electrolyzer placed downstream of the quench tower, configured to produce a hydrogen (H₂) stream and a H₂SO₄ acid stream;
a cooling system placed downstream of the electrolyzer, configured to cool the H₂SO₄ acid stream;
a buffer tank configured to receive a cooled H₂SO₄ acid stream;
   a first flowline coupled to the buffer tank, wherein the first flowline is configured to flow a first portion of the cooled H₂SO₄ acid stream from the buffer tank to the quench tower;
an enrichment unit placed downstream of the buffer tank, wherein the enrichment unit is configured to receive a second portion of the cooled H₂SO₄ acid stream from the buffer tank to produce a permeate stream and a retentate stream; and
a collection tank placed downstream of the enrichment unit, configured to receive the permeate stream from the enrichment unit.
   14. The system of embodiment 13, wherein the gas stream comprises hydrogen sulfide (H₂S), sulfur dioxide (SO₂), nitrogen (N₂), carbon dioxide (CO₂), water vapor, traces of sulfur trioxide (SO₃), traces of sulfur vapor, carbon monoxide (CO), carbonyl sulfide (COS), and carbon disulfide (CS₂).
   15. The system of embodiment 13 or 14, wherein the cooled effluent stream from the waste recovery system comprises CO₂, SO₂, water vapor, an excess of O₂, and traces of SO₃.
   16. The system of any of embodiments 13-15, wherein the lower section of the quench tower comprises a packing in which a dilute sulfuric acid (H₂SO₄) aqueous solution contacts the cooled effluent stream to form condensed water vapor and a dissolved SO₂, and further in the lower section a partial reaction of the dissolved SO₂ with the excess O₂ occurs to produce an aqueous H₂SO₄ acid solution, sulfurous acid (H₂SO₃), and unreacted dissolved SO₂.
   17. The system of any of embodiments 13-16, further comprising two liquid oxidant injection points, wherein a liquid oxidant is injected which results in complete oxidation of the unreacted dissolved SO₂ flowing out of the quench tower.
   18. The system of any of embodiments 13-17, further comprising an oxidation-reduction potential (ORP) analyzer placed downstream of the lower section of the quench tower, wherein the ORP analyzer is configured to measure conversion of dissolved SO₂ into the aqueous H₂SO₄ acid solution.
   19. The system of any of embodiments 13-18, wherein the enrichment unit comprises a reverse osmosis (RO) membrane, an electrodialysis unit, a distillation unit, or a combination thereof.
   20. A method of removing sulfur-containing gases in a tail gas stream using the system of claim 13, the method comprising:
receiving the tail gas stream comprising CO₂, SO₂, water vapor, an excess of O₂, and traces of SO₃ in a quench tower;
contacting the tail gas stream in a lower section of the quench tower with a dilute sulfuric acid (H₂SO₄) aqueous solution to form a condensed water vapor, and to dissolve SO₂ in the dilute H₂SO₄ aqueous solution or in the condensed water vapor to form a dissolved SO₂ aqueous solution;
partially reacting the dissolved SO₂ aqueous solution with the excess of O₂ in the tail gas stream to form an aqueous solution, wherein the aqueous solution comprises sulfurous acid (H₂SO₃), H₂SO₄ acid, and unreacted dissolved SO₂;
oxidizing completely the H₂SO₃ and the unreacted dissolved SO₂ by an electrolyzer or by injecting a liquid oxidant into the aqueous stream to form a H₂SO₄ aqueous stream;
flowing a first part of the H₂SO₄ aqueous stream to a reverse osmosis membrane to form a permeate stream comprising a water and a retentate stream comprising a concentrated H₂SO₄ acid;
flowing a second part of the H₂SO₄ aqueous stream to the quench tower.

What is claimed is:

1. A method for removing sulfur dioxide (SO₂) from a gas stream, the method comprising:
receiving a gas stream comprising CO₂, SO₂, water vapor, an excess of O₂, and traces of SO₃ in a quench tower;
contacting, in a lower section of the quench tower, the gas stream with a dilute sulfuric acid (H₂SO₄) aqueous solution, thereby:
forming a condensed water vapor; and
dissolving SO₂ in the dilute H₂SO₄ aqueous solution or in the condensed water vapor to form a dissolved SO₂ aqueous solution;
partially reacting the dissolved SO₂ aqueous solution with the excess of O₂ from the gas stream to form a partially oxidized stream comprising sulfurous acid (H₂SO₃), dilute H₂SO₄, and unoxidized dissolved SO₂;
oxidizing completely, from the partially oxidized stream, the unoxidized dissolved SO₂ and H₂SO₃ in an electrolyzer, or oxidizing the unoxidized dissolved SO₂ and H₂SO₃ by adding a liquid oxidant, to form a dilute H₂SO₄ acid stream, thereby resulting in the removal of SO₂;
cooling the dilute H₂SO₄ acid stream and splitting the cooled dilute H₂SO₄ acid stream into two portions;
flowing a first portion of the cooled dilute H₂SO₄ acid stream to a section above the lower section of the quench tower to contact an incoming gas stream; and
flowing a second portion of the cooled dilute H₂SO₄ acid stream to an enrichment unit.

2. The method of claim 1, further comprising producing a permeate stream and a retentate stream from the second portion of the cooled dilute H₂SO₄ acid stream wherein:
the permeate stream comprises 0.1-1 wt % of H₂SO₄ acid; and
the retentate stream comprises a concentrated H₂SO₄ acid stream of 30-98 wt %, wherein the retentate stream is flowed to a sulfur recovery unit.

3. The method of claim 2, further comprising flowing the permeate stream to an upper section of the quench tower.

4. The method of claim 1, wherein the quench tower has a perforated plate which separates an upper section of the quench tower and the lower section of the quench tower.

5. The method of claim 4, wherein the perforated plate distributes the dilute H₂SO₄ aqueous solution into the lower section of the quench tower.

6. The method of claim 1, wherein a variation in a flowrate or a composition of the gas stream results in a SO₂ gas breakthrough occurring from the lower section of the quench tower to the upper section of the quench tower.

7. The method of claim 6, wherein in response to the SO₂ gas breakthrough in the upper section of the quench tower, an aqueous stream is flowed into the upper section of the quench tower to absorb the SO₂ and oxidize the absorbed SO₂ with the excess of O₂, wherein the aqueous stream comprises a dilute acid water stream or a fresh water stream.

8. The method of claim 7, further comprising a change in a pH of the aqueous stream upon SO₂ gas breakthrough in the upper section of the quench tower, wherein in response to the change in the pH, the aqueous stream is flowed to the enrichment unit.

9. The method of claim 1, wherein the enrichment unit comprises a reverse osmosis (RO) membrane, an electrodialysis unit, a distillation unit, or a combination thereof.

10. The method of claim 1, wherein the liquid oxidant comprises nitric acid (HNO₃) or hydrogen peroxide (H₂O₂).

11. The method of claim 1, wherein the electrolyzer produces hydrogen (H₂) along with the dilute H₂SO₄ acid stream from the partially oxidized stream.

12. The method of claim 1, wherein the dilute H₂SO₄ aqueous solution contacting the gas stream is at a temperature ranging between 40-60° C.

13. A system for removing sulfur dioxide (SO₂) from a gas stream, the system comprising:
a thermal oxidizer comprising a combustion chamber, wherein the thermal oxidizer is configured to receive a gas stream and wherein the combustion chamber is configured to combust the gas stream;
a waste heat recovery system coupled to the thermal oxidizer, wherein the waste heat recovery system is configured to cool an effluent stream from the thermal oxidizer;
a quench tower comprising a lower section, a mid-section, and an upper section, wherein the quench tower is configured to receive a cooled effluent stream from the waste heat recovery system;
an electrolyzer placed downstream of the quench tower, configured to produce a hydrogen (H₂) stream and a H₂SO₄ acid stream;
a cooling system placed downstream of the electrolyzer, configured to cool the H₂SO₄ acid stream;
a buffer tank configured to receive a cooled H₂SO₄ acid stream;
a first flowline coupled to the buffer tank, wherein the first flowline is configured to flow a first portion of the cooled H₂SO₄ acid stream from the buffer tank to the quench tower;
an enrichment unit placed downstream of the buffer tank, wherein the enrichment unit is configured to receive a second portion of the cooled H₂SO₄ acid stream from the buffer tank to produce a permeate stream and a retentate stream; and
a collection tank placed downstream of the enrichment unit, configured to receive the permeate stream from the enrichment unit.

14. The system of claim 13, wherein the gas stream comprises hydrogen sulfide (H₂S), sulfur dioxide (SO₂), nitrogen (N₂), carbon dioxide (CO₂), water vapor, traces of sulfur trioxide (SO₃), traces of sulfur vapor, carbon monoxide (CO), carbonyl sulfide (COS), and carbon disulfide (CS₂).

15. The system of claim 13, wherein the cooled effluent stream from the waste recovery system comprises CO₂, SO₂, water vapor, an excess of O₂, and traces of SO₃.

16. The system of claim 13, wherein the lower section of the quench tower comprises a packing in which a dilute sulfuric acid (H₂SO₄) aqueous solution contacts the cooled effluent stream to form condensed water vapor and a dissolved SO₂, and further in the lower section a partial reaction of the dissolved SO₂ with the excess O₂ occurs to produce an aqueous H₂SO₄ acid solution, sulfurous acid (H₂SO₃), and unreacted dissolved SO₂.

17. The system of claim 16, further comprising two liquid oxidant injection points, wherein a liquid oxidant is injected which results in complete oxidation of the unreacted dissolved SO₂ flowing out of the quench tower.

18. The system of claim 17, further comprising an oxidation-reduction potential (ORP) analyzer placed downstream of the lower section of the quench tower, wherein the ORP analyzer is configured to measure conversion of dissolved SO₂ into the aqueous H₂SO₄ acid solution.

19. The system of claim 13, wherein the enrichment unit comprises a reverse osmosis (RO) membrane, an electrodialysis unit, a distillation unit, or a combination thereof.

20. A method of removing sulfur-containing gases in a tail gas stream using the system of claim 13, the method comprising:
receiving the tail gas stream comprising CO₂, SO₂, water vapor, an excess of O₂, and traces of SO₃ in a quench tower;
contacting the tail gas stream in a lower section of the quench tower with a dilute sulfuric acid (H₂SO₄) aqueous solution to form a condensed water vapor, and to dissolve SO₂ in the dilute H₂SO₄ aqueous solution or in the condensed water vapor to form a dissolved SO₂ aqueous solution;
partially reacting the dissolved SO₂ aqueous solution with the excess of O₂ in the tail gas stream to form an aqueous solution, wherein the aqueous solution comprises sulfurous acid (H₂SO₃), H₂SO₄ acid, and unreacted dissolved SO₂;
oxidizing completely the H₂SO₃ and the unreacted dissolved SO₂ by an electrolyzer or by injecting a liquid oxidant into the aqueous stream to form a H₂SO₄ aqueous stream;
flowing a first part of the H₂SO₄ aqueous stream to a reverse osmosis membrane to form a permeate stream comprising a water and a retentate stream comprising a concentrated H₂SO₄ acid;
flowing a second part of the H₂SO₄ aqueous stream to the quench tower.
